(19) United States
(12) Patent Application Publication
(10) Pub. No.: US 2005/0259020 A1
(43) Pub. Date: Nov. 24, 2005

(54) Combined electronic and mechanical scanning antenna

(75) Inventors: Raimondo Lo Forti, Guidonia Montecelio (Roma) (IT); Alessandro Rosa, Ardea (Roma) (IT)

Correspondence Address: John S. Egbert;Harrison & Egbert, 7th Floor, 412 Main Street, Houston, TX, 77002, US

(73) Assignee: TeS Teleinformatica e Sistemi S.r.l., Roma (IT)

(21) Appl. No.: 11/133,637

(22) Filed: May 20, 2005

(30) Foreign Application Priority Data
May 20, 2004 (IT) RM2004 A 000254

(51) Int. Cl. H01Q 3/00

(52) U.S. Cl. 343/757

(57) ABSTRACT

Combined electronic/mechanical scanning antenna for fixed installations such as ground-based self-propelled vehicles, automobiles, trucks, etc., ships, satellites, etc., to connect fixed or moving stations. It may be used for radar applications. Compared to the current state-of-the-art, it combines mechanical and electronic scanning devices in a single system. Technical field of electronic systems and radar telecommunications included. Field of application: production of telecommunications systems.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention presented concerns a combined electronic and mechanical scanning antenna to be used on a fixed installation or on a mobile vehicle, for example a ground-based self-propelled vehicle, car, truck, etc., on ships, planes, satellites, etc., to connect a fixed or moving station. The invention may also be used for radar applications, and (FIG. 1) is essentially constituted by three elements: “a phased array”, a rotating base and a mirror, which is optional, that rotates by means of a hinge.

### BACKGROUND OF THE INVENTION

“Phased array” is now a commonly used term and means a “phase-controlled” array antenna.

The antenna subject of the invention for which patent coverage is requested is lighter than previous ones, as it uses simpler, lighter and cheaper mechanical items than those available on the market, given that less mechanical scanning accuracy is required, as the electronic part does the fine scanning.

The antennas used until now had completely mechanical or completely electronic scanning systems.

The completely mechanical scanning technique used previously (FIG. 2a) was limited by the useful lifespan of the mechanical parts and higher costs for accurate mechanical positioning systems.

The completely electronic scanning technique previously used (FIG. 2b) involved very high costs due to the large size of the antenna and the high number and complexity of the electronic devices required due to the low efficiency of the rotating system.

### BRIEF SUMMARY OF THE INVENTION

The invention combines the mechanical and electronic scanning systems in a single device.

The invention is described below for illustrative and not limitative purposes, referring to the design tables attached and the version currently preferred by the inventors.

### BRIEF DESCRIPTION OF THE SEVERAL VIEWS OF THE DRAWINGS

FIG. 1a—Schematic representation of the antenna in which the mirror (optional) is in the inclined position.

FIG. 1b—Schematic representation of the antenna in which the mirror (optional) is in the flat position.

FIG. 2a—Schematic representation of an aperture antenna which carries out a complete mechanical scanning through an elevation movement and an azimuth movement.

FIG. 2b—Schematic representation of a “phased array” antenna in which every single element of the array requires a radio frequency chain composed of diplexers, phase shifters, amplifiers, etc. and a rather complex electronic control system. In this case, scanning is purely electronic.

The antennas shown in FIGS. 2a and 2b are included as examples in as much as they are representative of two different technologies: purely mechanical scanning and purely electronic scanning.

In the invention presented, the two technologies (mechanical scanning and electronic scanning) are used simultaneously.

FIG. 3—“Phased array” representation.

FIG. 4—Representation of a polarizer divided into 18 sections.

### DETAILED DESCRIPTION OF THE INVENTION

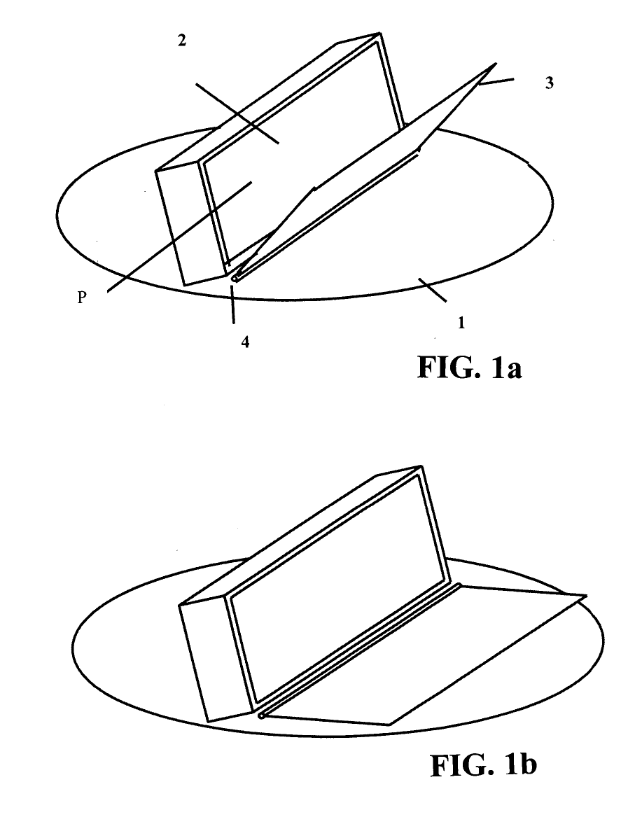

With reference to FIG. 1a, the following are visible: azimuth dish 1, “phased array” 2, mirror 3, hinge 4, polarizer P.

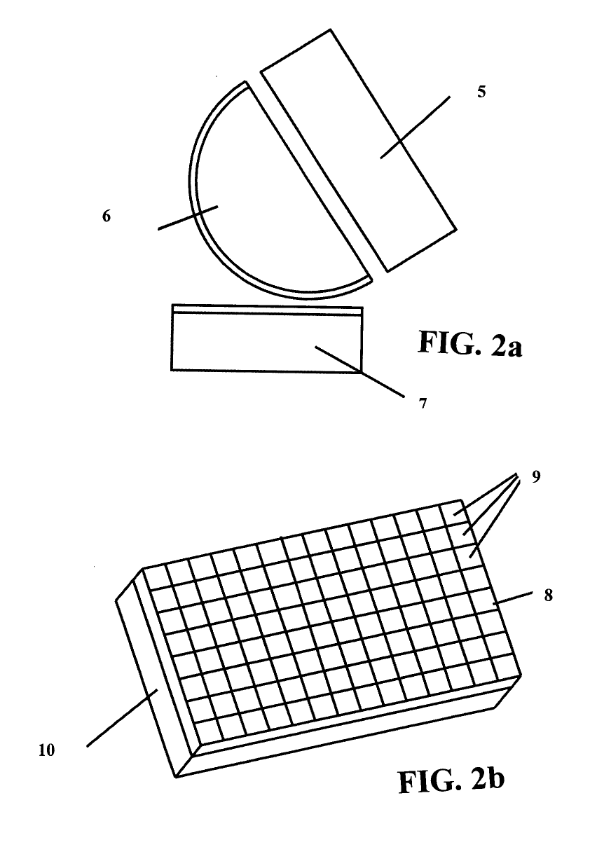

With reference to FIG. 2, which represents a previous solution, the following are visible in (a): aperture antenna 5, elevation movement 6, azimuth movement 7; in (b): “phased array” 8, single elements with control electronics 9; control electronics 10.

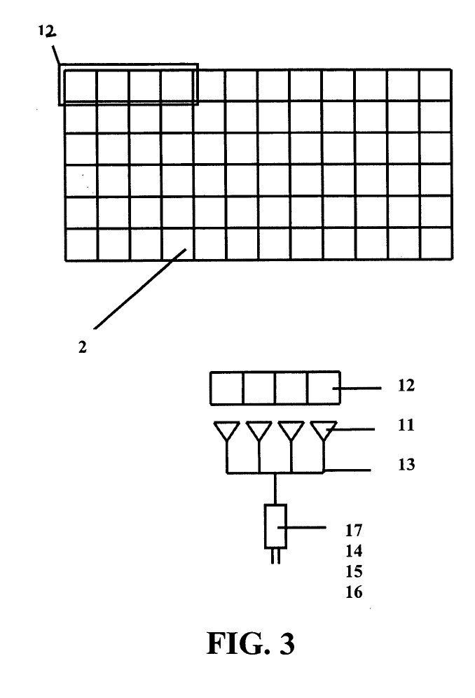

With reference to FIG. 3, the following are visible: “phased array” 2, rotary element 11, sub-array 12, power supply network 13, phase shifter 14, diplexer 15, amplifier 16, control electronics 17.

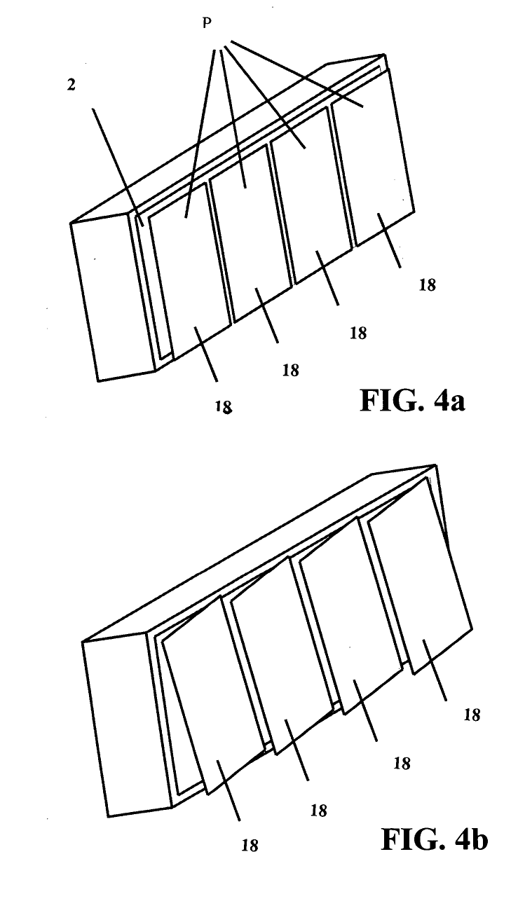

With reference to FIG. 4, the panel P is divided into 18 sections which can rotate separately, changing the polarization alignment. In 4a, the 18 sections are shown closed, while in 4b, they are shown open.

As already mentioned, the two technologies are used simultaneously in the invention: azimuth scanning of the antenna beam and elevation scanning of the antenna beam.

Azimuth scanning of the antenna beam is obtained through both mechanical and electronic movement. Mechanical movement is obtained through the rotation of the azimuth dish 1. This movement does not require spot on accuracy as scanning accuracy is obtained through electronic scanning within a limited angular sector. The possibility of electronic scanning is obtained through the use of control electronics limited to groups of radial elements of the array (sub-array) because the angular range of azimuth electronic scanning is limited. It should be noted that compared to FIG. 2b, which concerns a previous technique, the invention shows a significant reduction in the number of both radio frequency elements and the control electronics elements, as all these elements are functionally connected to the sub-arrays and not the single rotating elements.

For elevation scanning with the antenna, the proposed solution has the “phased array” mechanically fixed and the entire angular elevation section is covered using two or more antenna configurations:
an antenna configuration for low elevations with the mirror in the flat position, in other words not used, in which only the electronic scanning of the “phased array” is used;
one or more antenna configurations for high elevation angles involving the mirror placed at a “definite angle” to the “phased array”.

A “definite angle” means that the angle between the mirror and the “phased array” depends on the application of the system, in other words the extent of the elevation which requires coverage.

For some applications, the presence of the mirror is not required as the electronic scanning of the “phased array” is sufficient.

The coverage of high angles of elevation is obtained through the electronic scanning of the sector covered and reflection on the mirror. This is the advantage of using electronic scanning and the mirror simultaneously.

The structure of the “phased array”, 2, is constituted by a series of radial elements, 11. Such series may be configured as desired. All elements in 11 are grouped in linear sub-arrays of n elements, 12, where n depends on the extension of the electronic azimuth scanning sector, which in turn depends on the mechanical scanning accuracy.

The radial elements of a sub-array have a power supply network 13 which connects them to the control electronics 17.

The radio frequency chain 17 is constituted by, for example:
phase shifter 14
diplexer 15
power amplifiers 16 (for the transmitting radio frequency chains) and/or low sound amplifier (for receiving radio frequency chains). The above-mentioned devices are not described as they are well known.

Another original aspect is the use of a limited number of radio frequency components and, consequently, a lowering of the costs and a significant reduction of the complexity of the system architecture. Furthermore, the polarization of the antenna may be varied by both mechanically modifying the inclination of the grids, in the case of a single polarization system, and by modifying the power supplies of the radial elements with double polarization, in the case of a double polarization system.

The “phased array” 2 works through the variation of the status of the phase shifters and amplifier(s) 16. By changing the power supply of each sub-array compared to the others, the required variation for the scanning of the sector is obtained. The movement required for the sector is limited to little more than the compensation of the accuracy of the mechanical movement.

The azimuth dish (rotating base) guarantees azimuth movement. It is activated by a motor which determines its positioning.

The mirror is a strip or grid of conducting material (metal), the size of which depends upon the application required and the elevation scanning requirements. It may also be set in a non-flat position in order to suitably modify the antenna range and/or the sector to be scanned by same.

The linear polarization rotator P, FIG. 1a and FIG. 1b, is a panel located on the aperture of the “phased array”.

The panel is formed by several layers of dielectric materials and two or more metallic grids rotated to each other but rigidly connected. This has the aim of correcting the polarization de-alignment of the electromagnetic field of a linear polarization antenna, which may be caused, for example, by the oscillation of the device on which the antenna is mounted.

In our case, the polarization rotator acts dynamically through the rotation of the metallic grids with respect to each other and with respect to the aperture of the “phased array”. Naturally, the various layers of the polarization rotator are no longer integral to each other. Rotation may occur, for example, by dividing the panel P, FIG. 4a, into 18 sections, which may be rotated separately, as in FIG. 4b, varying the polarization alignment.

In the case of antenna systems requiring double linear polarization, the polarization may not be aligned by using the polarization rotator. Therefore, to carry out the required polarization alignment, the radio frequency chains connected to double polarization radial elements needs to be doubled. In this case, the desired linear polarization alignment is obtained by making the necessary variations in width to the two inputs of each radial element.

1. Combined electronic/mechanical scanning antenna, comprising:
a rotating base or azimuth dish being positionable;
a phased array positioned on the base;
a mirror, which is optional, equipped with a hinge;
an electronic control system; and
a polarizer.

2. Combined electronic/mechanical scanning antenna, as in claim 1, wherein said phased array is positioned on the azimuth dish at an angle ranging from 0 to 90°.

3. Combined electronic/mechanical scanning antenna, as in claim 1, wherein said mirror has one or more stable positions chosen beforehand.

4. Combined electronic/mechanical scanning antenna, as in claim 1, wherein said hinge enables inclination of the mirror and coincides with the lower corner of said phased array.

5. Combined electronic/mechanical scanning antenna, as in claim 1, wherein said electronic control system is comprised of several sub-arrays, a phase shifter, a diplexer, one or more amplifiers, and an amplification network.

6. Combined electronic/mechanical scanning antenna, as in claim 1, wherein said base is located on a fixed station or on board aircraft, ships, satellites, mobile means, etc.

7. Combined electronic/mechanical scanning antenna, as in claim 1, wherein said mirror is absent.

8. Combined electronic/mechanical scanning antenna as in claim 1, wherein said base is located to connect fixed or moving stations.

9. Combined electronic/mechanical scanning antenna, as in claim 1, wherein polarization is varied by mechanically modifying inclination of grids, in the case of a single polarization system.

10. Combined electronic/mechanical scanning antenna, as in claim 1, wherein polarization changes by modifying the power supplies of double polarization radial elements, in the case of a double polarization system.
